(19) United States
(12) Patent Application Publication
(10) Pub. No.: US 2022/0327637 A1
(43) Pub. Date: Oct. 13, 2022

(54) INTERACTION BASED SOCIAL DISTANCE QUANTIFICATION

(71) Applicant: Microsoft Technology Licensing, LLC, Redmond, WA (US)

(72) Inventors: Neha Parikh Shah, Glen Ridge, NJ (US); Tannaz Sattari Tabrizi, Kirkland, WA (US); George Hampton Atherton, Sammamish, WA (US); Jonathan Karl Larson, Bremerton, WA (US)

(21) Appl. No.: 17/227,809

(22) Filed: Apr. 12, 2021

(51) Int. Cl. G06Q 50/00; G06N 3/02; G06F 16/901

(52) U.S. Cl. CPC G06Q 50/01; G06N 3/02; G06F 16/9024

(57) ABSTRACT

Techniques for interaction based social distance quantification are discloses herein. In one example, a method includes generating an interaction graph having (i) multiple vertices individually corresponding to multiple users and (ii) multiple directional edges individually connecting pairs of the multiple vertices. The method can also include applying graph embedding to convert the multiple vertices in the generated graph into corresponding tensors in a vector space. The method can further includes determining and outputting a social distance value between the one of the multiple users and another of the multiple users by calculating a tensor distance in the vector space between tensors corresponding to the one of the multiple users and the another of the multiple users.

### BACKGROUND

In computing, a social network is a computer service that provides an online platform configured to allow people to interact with other people or with content hosted on the social network via a computer network such as the Internet. For example, a user can utilize a social network to broadcast messages via a social network account. Such posts can contain text, photos, videos, audios, or other suitable types of electronic content. In response, other users of the social network can repost, reply, comment, like, or perform other actions on the original messages. Such interactions can allow the users to share similar interests, activities, ideologies, or real-life connections.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Relational closeness of users in a social network is useful for the social network to provide relevant suggestions of content, potential connections, or other information to the users in the social network. For example, the social network can recommend a website or webpage to a user when other users connected to the user have visited the website or webpage. In another example, the social network can also recommend additional users as potential connections to a user based on connections of other users. In a further example, the social network can also recommend a team, group, department, or other types of organization to a user when connected users are members of such an organization. Such recommendations can allow the user to access relevant information, establish new connections, and otherwise enrich user experience of the social network.

Various metrics have been developed to gauge relational closeness of users in a social network. For example, one closeness metric is based on numbers of connections or “hops” connecting two users in a social network. For example, when a first user is directly connected to a second user in a social network, the closeness metric can be set to one because only one hop is needed for the first user to reach the second user in the social network. In another example, when a first user is connected to a second user via one or more intermediate users, the closeness metric can be set to two or more because two or more hops are needed for the first user to reach the second user in the social network. In other examples, closeness metrics can also be based on types of relationships (e.g., managers and subordinates), length of connections (e.g., years being connected), and other suitable parameters.

The existing closeness metrics, however, do not typically consider degrees of interactions between pairs of users in the social network when gauging relational closeness of the users. For example, a first user may be remote to a second user in a social network because many hops are needed for the first user to reach the second user in the social network. Alternatively, the first user may not even be connected to the second user at all. However, the first user has frequently exchanged emails, text messages, or other suitable types of interactions with the second user. Such frequent interactions would indicate closeness of the first user to the second user. However, the existing closeness metrics may deem the first and second users as not closely related despite such frequent interactions due to the remoteness or the lack of connections between the first and second users.

Several embodiments of the disclosed technology can address certain aspects of the foregoing drawbacks by implementing a data processor configured to implement social distance quantification based on user interactions via graph embedding. In certain implementations, the data processor can include a telemetry monitor, a graph inducer, a graph analyzer, and a social distance quantifier operatively coupled to one another. In other implementations, at least one of the foregoing components can be separate from the data processor. In further implementations, the data processor can also include other suitable components in additional to or in lieu of the foregoing components of the data processor.

The telemetry monitor can be configured to detect interactions of users in a social network. Such interactions can be with other users of the social network, with content (e.g., documents) hosted in the social network, or with teams, groups, or other suitable types of organizations in the social network. For example, the telemetry monitor can be configured to detect that a first user has exchanged several emails with a second user in addition to exchanging instant messages with other users in the social network. Such monitoring can be performed with user consent to protect user privacy and may be opted out. Upon detecting such interactions, the telemetry monitor can be configured to generate database records corresponding to the detected interactions. For example, a database record can include suitable data fields corresponding to a type (e.g., email), date/time, recipient, or other suitable parameters of an interaction. The telemetry monitor can also be configured to compile the database records as a dataset of interactions. In other implementations, the telemetry monitor can be separate from the data processor and instead can be configured to allow the data processor to access the compiled dataset of interactions via, for instance, an Application Programming Interface (API).

The graph inducer of the data processor can be configured to induce the compiled dataset of interactions into an interaction graph. In certain embodiments, the graph inducer can represent a user (or a corresponding email or other types of user account) as a vertex in a graph and each detected interaction as an edge between two or more vertices. For example, a first vertex can represent a first user while a second vertex can represent a second user. A directional edge can connect the first and second vertices to represent an email the first user sent to the second user. Another directional edge can connect the first vertex to a third vertex corresponding to a third user when the first user sent the same or different email to the third user. Thus, an edge pointing from the first vertex to the second or third vertex can represent a detected email transmitted from the first user to the second or third user. Another edge pointing from the second or third vertex to the first vertex can represent an email reply from the second or third user to the first user.

In certain embodiments, the edge can be weighted, for instance, based on how many recipients an email is addressed to. For example, an email addressed to only one user can be assigned to carry a higher weight than an email addressed to many users. Thus, in one example, the graph inducer can be configured to assign a weight to an edge that is an inverse of the number of recipients the email is addressed to. In other examples, the graph inducer can be configured to assign a fixed weight (e.g., one) to all emails while filtering emails with more than a threshold (e.g., four) of recipients. In additional embodiments, the edge can be weighted based on whether a reply to the email is received, an elapsed time between a reply to the email and transmission of the email, or other suitable parameters of the email interactions and/or in other suitable manners.

Upon inducing the interaction graph from the dataset of interactions, the graph analyzer can be configured to apply graph embedding to the induced interaction graph to generate a vertex level tensor-based embedding for each user represented by the vertices in the interaction graph. In computing, graph embedding generally refers to techniques used to transform vertices, edges, and associated features (e.g., represented by weights of edges) into tensors in a vector space of certain dimensions (e.g., 256 dimensions) while maximally preserving graph structure and information.

According to one graph embedding technique, a vertex in a graph can be represented as a combination of non-linear transformations of an aggregation of features from connected neighbors and ultimately the entire latent space of the graph of the vertex and features of the vertex itself. For example, when user A is connected to users B, C, and D in the interaction graph, features of vertex A representing user A can be computed as a non-linear transformation of an aggregate of features from vertices corresponding to users B, C, and D combined with a non-linear transformation of features of vertex A by applying encoding functions. When users B, C, and D are connected to additional users in the interaction graph, each user B, C, and D can be represented similarly as aggregations of features from respective neighbors by applying additional encoding functions. As such, each vertex in the interaction graph can have a corresponding computational graph that captures neighborhood structure of the interaction graph around the vertex as well as features of the vertex and corresponding neighbors.

The encoding functions for both the aggregate features of connected neighbors and the vertex itself can be developed via machine learning by, for example, using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer to an output layer, possibly after traversing one or more intermediate layers.

Training the neural network to develop the encoding functions can be performed in a supervised, semi-supervised, or unsupervised fashion. For example, the neural network can be trained using a loss function based on random walks (e.g., node2vec, DeepWalk, struc2walk, etc.), graph factorization, or node proximity in a graph. During graph embedding, the graph analyzer can also be configured to tune how the neural network performs graph embedding. For example, when performing random walks within node2vec, the graph analyzer can apply differing numbers of random walks based on a degree centrality of a vertex in the graph. As such, oversampling of vertices with very few connections could be prevented. In another example, when performing window calculations (e.g., how many vertices are considered in a window), the graph analyzer can be configured to use a very narrow window size (e.g., two). Thus, by using such techniques, the graph analyzer can develop encoding functions for both the aggregate of connected neighbors as well as for each vertex itself. The encoding functions (or machine learning models) can then be used to convert each vertex in the graph into a tensor in a vector space individually representing a position and/or a level of interaction between users in the social network.

Upon obtaining the tensors corresponding to the users represented by the vertices in the graph, the social distance quantifier can be configured to quantify a social distance based on interactions between a pair of users using corresponding tensors. For example, the social distance can be computed using tensor distance metrics such as dot product distance, cosine similarity, or Euclidean distance. As such, for each user, the social distance quantifier can produce a set of tensor distances. Based on the tensor distances, the social distance quantifier can be configured to rank other users in the social network for closeness to a user based on interactions of among the users. Though the technique is described above in the context of user interactions with other users, similar techniques can also be applied in the context of user interactions with content or interactions with teams, groups, or other suitable types of organizations on the social network or other suitable types of computing network.

Several embodiments of the disclosed technology can be applied to resolve the technical issue of quantifying degrees of interactions in a social network using machine learning. By constructing the interaction graph, interaction features or properties, such as exchange of emails, the number of emails exchanged, recency of exchanged emails, etc., can be graphically represented. The graphically represented interaction features can then be converted into vertex level tensors in a vector space via graph embedding. Using the vertex level tensors, the data processor can readily determine social distances based on interactions between the users as tensor distances between pairs of the tensors. As such, social distance values corresponding to degrees of interactions of the users can be readily quantified and visualized.

The quantified social distance values can be useful in providing suggestions of potential connections, content, or organizations based on user interactions in a social network. For example, when a new user joins a team to replace a previous user, the data processor can be configured to suggest to the new user potential connections of other users in the team according to a ranking of social distance of the other users to the previous user. In another example, when a new user joins a team but not to replace any other users in the team, an average, medium, or other suitable values of tensors from other users can be used to calculate estimated social distances from users in the team. As such, the new user is likely to quickly establish valuable relationship with other users in the team with whom the new user is likely to interact. In further examples, the data processor can also be configured to similarly suggest content items or groups to the new user such that the new user can be exposed to likely useful information or activities.

### BRIEF DESCRIPTION OF THE DRAWINGS

FIG. 1 is a schematic diagram illustrating a computing system implementing interaction based social distance quantification in accordance with embodiments of the disclosed technology.

FIGS. 2A-2D are schematic diagrams illustrating certain components and operations of a data processor performing interaction based social distance quantification in the computing platform of FIG. 1 in accordance with embodiments of the disclosed technology.

FIGS. 3A and 3B are flowchart illustrating example processes of interaction based social distance quantification and uses thereof in accordance with embodiments of the disclosed technology.

FIG. 4 is a computing device suitable for certain components of the distributed computing system in FIG. 1.

### DETAILED DESCRIPTION

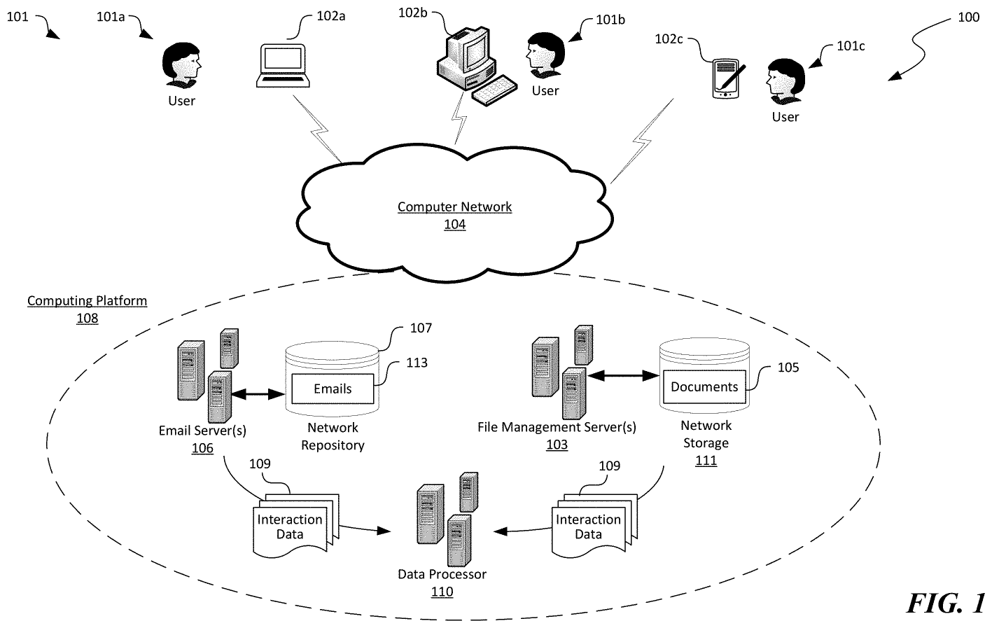

Certain embodiments of systems, devices, components, modules, routines, data structures, and processes for interaction based social distance quantification are described below. In the following description, specific details of components are included to provide a thorough understanding of certain embodiments of the disclosed technology. A person skilled in the relevant art will also understand that the technology can have additional embodiments. The technology can also be practiced without several of the details of the embodiments described below with reference to FIGS. 1-4.

Many terminologies are used herein to illustrate various aspects of the disclosed technology. Such terminologies are intended as examples and not definitions. For instance, a computing platform can be a computing facility having a computer network interconnecting a plurality of servers or hosts to one another or to external networks (e.g., the Internet). An example of such a computing facility can include a datacenter for providing cloud computing services. A compute network can include a plurality of network devices. A network device can be a physical network device, examples of which include routers, switches, hubs, bridges, load balancers, security gateways, or firewalls. A host or host device can include a computing device that is configured to implement, for instance, one or more virtual machines, containers, or other suitable virtualized components. For example, a host can include a remote server having a hypervisor configured to support one or more virtual machines, containers, or other suitable types of virtual components. In another instance, a host can also include a desktop computer, a laptop computer, a smartphone, a web-enabled appliance (e.g., a camera), or other suitable computing devices configured to implement one or more containers or other suitable types of virtual components.

In another example, a computing service or cloud service can include one or more computing resources provided over a computer network such as the Internet. Example cloud services include software as a service (SaaS), platform as a service (PaaS), and infrastructure as a service (IaaS). SaaS is a software distribution technique in which software applications are hosted by a cloud service provider in, for instance, datacenters, and accessed by users over a computer network. PaaS generally includes delivery of operating systems and associated services over the computer network without requiring downloads or installation. IaaS generally includes outsourcing equipment used to support storage, hardware, servers, network devices, or other components, all of which are made accessible over a computer network.

In addition, a social network can include a computer network and/or associated computer service that provides an online platform configured to allow users to interact with other users or with content hosted on the social network via a computer network such as the Internet. Interactions on such a social network can include exchanging emails, instance messages, text messages, VoIP calls, etc. between users, as well as access, edit, create, or otherwise manipulating documents, videos, voice recordings, or other suitable types of content items. Various interactions of the users in the social network can be represented by a graph structure or other suitable types of data structures. In a graph structure, multiple vertices can correspond to corresponding users, content items, or groups in a social network. The graph can also include edges that connect pairs of the vertices. The edges can include both a direction and a weight. As discussed in more detail later, the direction can correspond to a direction of interaction between users while the weight can be assigned according to various criteria.

FIG. 1 is a schematic diagram illustrating a computing system 100 implementing interaction based social distance quantification in accordance with embodiments of the disclosed technology. As shown in FIG. 1, the computing system 100 can include a computer network 104 interconnecting a plurality of client devices 102 of corresponding users 101 and a computing platform 108. The computer network 104 can include an enterprise intranet, a social network, the Internet, or other suitable types of network. Even though particular components of the computing system 100 are shown in FIG. 1, in other embodiments, the computing system 100 can also include network storage devices, maintenance managers, and/or other suitable components (not shown) in addition to or in lieu of the components shown in FIG. 1.

The client devices 102 can individually include a computing device that facilitates access to various resources, such as emails, social network services, file management services via the computer network 104 by the users 101 (identified as first, second, and third users 101a-101c). For example, in the illustrative embodiment, the first computing device 102a includes a laptop computer. The second computing device 102b includes a desktop computer. The third computing device 102c includes a tablet computer. In other embodiments, the client devices 102 can also include smartphones or other suitable computing devices. Even though three users 101 are shown in FIG. 1 for illustration purposes, in other embodiments, the computing system 100 can facilitate operations by any suitable number of users 101 via the computer network 104.

The computing platform 108 can be configured to facilitate interactions among the users 101 as well as between the users 101 and content items hosted in the computing platform 108. For example, as shown in FIG. 1, the computing platform 108 can include a network storage 111 operatively coupled to file management servers 103, a network storage repository 107 operatively coupled to email servers 106, and a data processor 110 operatively coupled to the email servers 106 and the file management servers 103. As shown in FIG. 1, the network storage 111 can be configured to store records of documents 105 accessible to the users 101 via the computer network 104. The network repository 107 can also be configured to store records of emails 113 of the individual users 101. In certain embodiments, the file management servers 103, the email servers 106, and the contact servers 108 can individually include one or more interconnected computer servers, as shown in FIG. 1. In other embodiments, the foregoing components of the computing platform 108 can each include a cloud-based service hosted on one or more remote computing facilities such as datacenters. In further embodiments, certain components (e.g., the file management servers 103) may be omitted from the computing platform 108 and be provided by external computing systems (not shown).

The file management servers 103 can be configured to implement certain policies to facilitate access of the documents 105 by the users 101 via the computer network 104. For example, in one embodiment, the file management servers 103 can implement access control policies such that certain class, type, category, or other suitable grouping of the documents 105 can be accessible to certain users 101. In another embodiment, the file management servers 103 can also implement file retention policies such that certain class, type, category, or other suitable grouping of the documents 105 can be automatically deleted or purged from the network storage 111. In further embodiments, the file management servers 103 can implement other suitable types of policies to regulate storing, editing, accessing, purging, or other suitable operations on the documents 105.

The email servers 106 can be configured to running suitable applications that are configured to facilitate email interactions among the users 101. For example, the email servers 106 can be configured to receive incoming emails 113 from senders and forward outgoing emails 113 to recipients via the computer network 104. In certain implementations, the email servers 106 can be configured to maintain and/or access one or more inboxes for corresponding users 101 at the network repository 107. Periodically or upon demand, the email servers 106 can be configured to receive and forward emails 113 from the inboxes to the client devices 102 of the users 101.

The data processor 110 can be configured to monitor interactions of the users 101 on the computing platform 108 and perform interaction based social distance quantification for the users 101. For example, as shown in FIG. 1, the file management servers 103 and the email servers 106 can transmit interaction data 109 to the data processor 110 periodically, on demand, based on event, or in other suitable manners. The interaction data 109 can include data indicating a type, date/time, recipient, or other suitable parameters of the interaction. For example, the interaction data 109 can indicate that the first user 101a transmitted an email 113 to the second user 101b on Mar. 25, 2021, at 2:30 PM. In another example, the interaction data 109 can also indicate that the third user 101c has edited a document 105 stored in the network storage 111. Such collection of the interaction data 109 can be performed with user consent to protect user privacy and may be opted out.

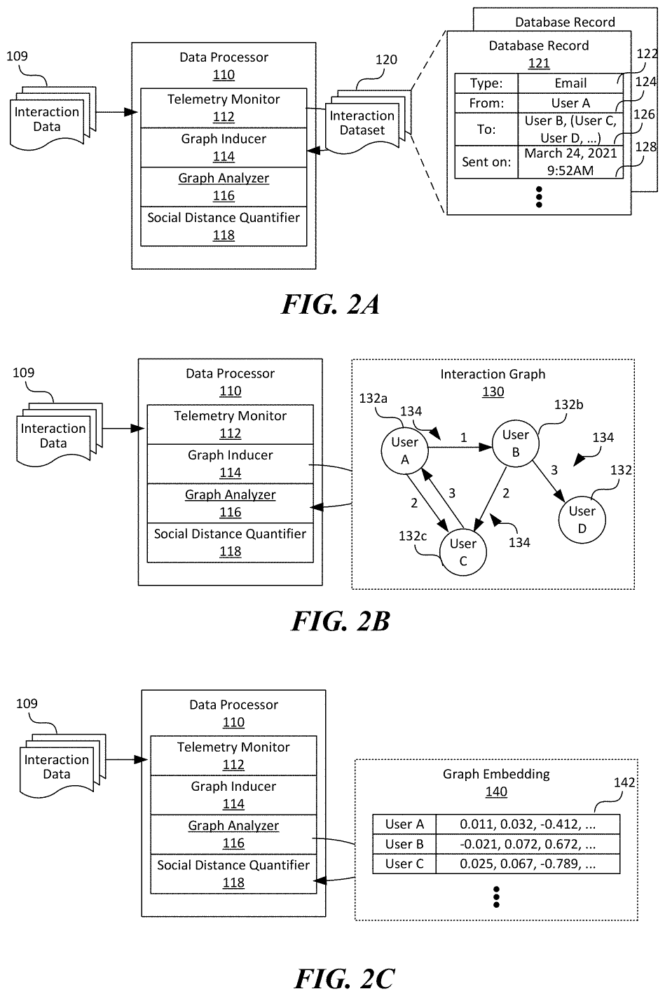

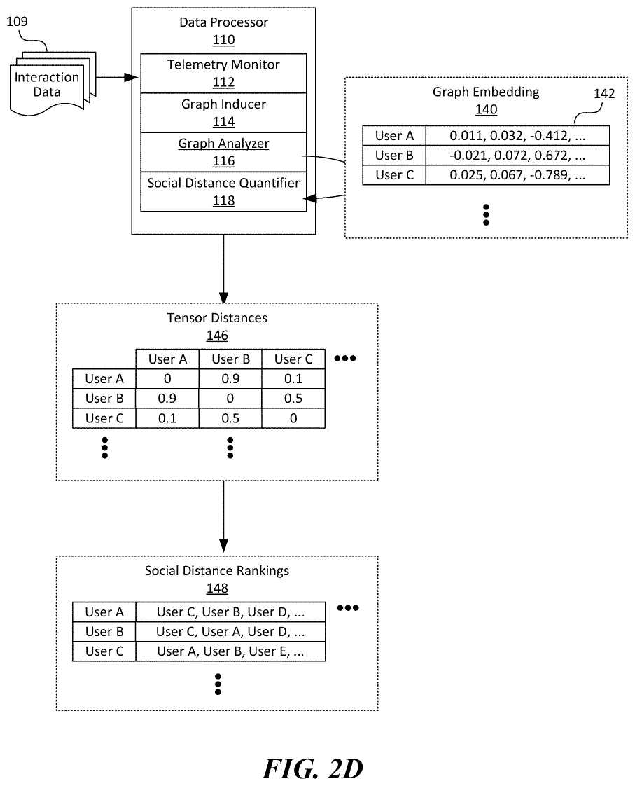

In certain embodiments, the data processor 110 can be configured to query the file management servers 103 and the email servers 106 for the interaction data 109. In other embodiments, the file management servers 103 and the email servers 106 can individually include a reporting agent (not shown) that collects and transmit to the data processor 110 the interaction data 109. In further embodiments, other suitable arrangements may be used to collect the interaction data 109 from the file management servers 103 and the email servers 106. In further embodiments, the data processor 110 can also be configured to collect and monitor interaction data 109 related to interactions via instant messaging, online meetings, VoIP calls, or via other communication channels. With the received interaction data 109, the data processor 110 can be configured to implement social distance quantification based on user interactions via graph embedding such that social distance values for each pair of the users 101 can be derived, as described in more detail below with reference to FIGS. 2A-2D.

FIGS. 2A-2D are schematic diagrams illustrating certain components and operations of the data processor 110 performing interaction based social distance quantification in the computing platform 108 of FIG. 1 in accordance with embodiments of the disclosed technology. As shown in FIG. 2A, the data processor 110 can include a telemetry monitor 112, a graph inducer 114, a graph analyzer 116, and a social distance quantifier 118 operatively coupled to one another. Though particular components of the data processor 110 are shown in FIG. 2A, in other embodiments, at least one of the foregoing components can be separate from the data processor 110. In yet further implementations, the data processor 110 can also include other suitable components in additional to or in lieu of the foregoing components of the data processor 110.

As shown in FIG. 2A, the telemetry monitor 112 can be configured to detect, from the received interaction data 109, interactions of users 101 (FIG. 1) on the computing platform 108 (FIG. 1). Such interactions can be with other users 101, with content (e.g., documents 105) hosted in the computing platform 108, or with teams, groups, or other suitable types of organizations in the computing platform 108. For example, the telemetry monitor 112 can be configured to detect, from the received interaction data 109, that the first user 101a has exchanged several emails 113 (FIG. 1) with the second user 101b in addition to exchanging instant messages with other users 101.

Upon detecting such interactions, the telemetry monitor 112 can be configured to generate database records 121 corresponding to the detected interactions. As shown in FIG. 2A, a database record 121 can include suitable data fields corresponding to various parameters of the interaction. For example, as shown in FIG. 2A, the data fields can include a type field 122 (e.g., “Email”), a sender field 124 (e.g., “User A”), a recipient field 126 (e.g., “User B”), and a date/time field 128 (e.g., “Mar. 24, 2021, 9:52 AM”). In other examples, the database record 122 may include other suitable types of data fields. The telemetry monitor can also be configured to compile the database records 122 as a dataset 120 of interactions containing multiple database records 121, as a table with columns and rows, or in other suitable formats. In other implementations, the telemetry monitor 112 can be separate from the data processor 110 and instead can be configured to allow the data processor 110 to access the compiled dataset of interactions via, for instance, an Application Programming Interface (API).

The graph inducer 114 can be configured to induce the compiled dataset 120 of interactions from the telemetry monitor 112 into an interaction graph 130. In certain embodiments, as shown in FIG. 2B, the graph inducer 114 can represent a user 101 (or a corresponding email or other types of user account) as a vertex 132 in the interaction graph 130 and each detected interaction as an edge 134 between two or more vertices 132. For example, a first vertex 132a can represent the first user 101a (FIG. 1) while a second vertex 132b can represent the second user 101b (FIG. 1). A directional edge 134 can connect the first and second vertices 132a and 132b to represent an email 113 (FIG. 1) the first user 101a sent to the second user 101b. Additional edges 134 can connect the first vertex 132a to a third vertex 132c corresponding to the third user 101c (FIG. 1) when the first user 101a sent the same or different email to the third user 101c and received a reply from the third user 101c. Thus, an edge pointing from the first vertex 132a to the second or third vertex 132b or 132c can represent a detected email transmitted from the first user 101a to the second or third user 101b and 101c. Another edge 134 pointing from the second or third vertex 132b or 132c to the first vertex 132a can represent an email reply from the second or third user 101b or 101c to the first user 101a.

In certain embodiments, the edges 132 can be weighted, for instance, based on how many recipients an email 113 is addressed to. For example, an email 113 addressed to only one user 101 can be assigned to carry a higher weight than an email 113 addressed to many users 101. Thus, in one example, the graph inducer 114 can be configured to assign a weight to an edge 134 that is an inverse of the number of recipients the email 113 is addressed to. In other examples, the graph inducer can be configured to assign a fixed weight (e.g., one) to all emails 113 while filtering emails 113 with more than a threshold (e.g., four) of recipients. Thus, as shown in FIG. 2B, numbers next to the edges 134 individually represent how many emails 113 one user 101 has sent to another. For instance, in the illustrated example, User A has sent two emails 113 to User C while User C has sent three emails 113 to User A. In additional embodiments, the edge can be weighted based on whether a reply to the email is received, an elapsed time between a reply to the email and transmission of the email, or other suitable parameters of the email interactions and/or in other suitable manners.

Upon inducing the interaction graph 130 from the dataset 120 of interactions, the graph analyzer 116 can be configured to apply graph embedding to the induced interaction graph 130 to generate a vertex level tensor-based embedding for each user 101 represented by the vertices 132 in the interaction graph 130. In computing, graph embedding generally refers to techniques used to transform vertices, edges, and associated features (e.g., represented by weights of edges) into tensors in a vector space of certain dimensions (e.g., 256 dimensions) while maximally preserving graph structure and information.

According to one graph embedding technique, a vertex in a graph can be represented as a combination of non-linear transformations of an aggregation of features (e.g., the number of emails 113 exchanged) from connected neighbors of the vertex 132 and features of the vertex 132 itself. For example, when user A is connected to users B, C, and D in the interaction graph 130, features of vertex A representing user A can be computed as a non-linear transformation of an aggregate of features from vertices 132 corresponding to users B, C, and D combined with a non-linear transformation of features of vertex A by applying encoding functions. When users B, C, and D are connected to additional users in the interaction graph 130, each user B, C, and D can be represented similarly by applying additional encoding functions. As such, each vertex 132 in the interaction graph 130 can have a corresponding computational graph that captures neighborhood structure of the interaction graph 130 around the vertex as well as features of the vertex 132 and corresponding neighbors.

The encoding functions for both the aggregate features of connected neighbors and the vertex 132 itself can be developed via machine learning by, for example, using a “neural network” or “artificial neural network” configured to “learn” or progressively improve performance of tasks by studying known examples. In certain implementations, a neural network can include multiple layers of objects generally refers to as “neurons” or “artificial neurons.” Each neuron can be configured to perform a function, such as a non-linear activation function, based on one or more inputs via corresponding connections. Artificial neurons and connections typically have a contribution value that adjusts as learning proceeds. The contribution value increases or decreases a strength of an input at a connection. Typically, artificial neurons are organized in layers. Different layers may perform different kinds of transformations on respective inputs. Signals typically travel from an input layer to an output layer, possibly after traversing one or more intermediate layers.

Training the neural network to develop the encoding functions can be performed in a supervised, semi-supervised, or unsupervised fashion. For example, the neural network can be trained using a loss function based on random walks (e.g., node2vec, DeepWalk, struc2walk, etc.), graph factorization, or node proximity in a graph. During graph embedding, the graph analyzer 116 can also be configured to tune how the neural network performs graph embedding. For example, when performing random walks within node2vec, the graph analyzer 116 can apply differing numbers of random walks based on a degree centrality of a vertex in the graph 130. As such, oversampling of vertices 132 with very few connections could be prevented. In another example, when performing window calculations (e.g., how many vertices are considered in a window), the graph analyzer 116 can be configured to use a very narrow window size (e.g., two). Thus, by using such techniques, the graph analyzer 116 can develop encoding functions for both the aggregate of connected neighbors as well as for each vertex itself.

The encoding functions (or machine learning models) can then be used to convert each vertex 132 in the graph 130 into a graph embedding 140 having tensors 142 in a vector space individually representing a position and/or a level of interaction between users in the social network. For example, as shown in FIG. 2C, User A can have a tensor value of “0.011, 0.032, −0.412, . . . ;” User B can have a tensor value of “−0.021, 0.072, 0.672, . . . ;” and User C can have a tensor value of “0.025, 0.067, −0.789, . . . ” The tensor values for each user 101 can have any suitable numbers in accordance with a number of dimensions in the vector space.

Upon obtaining the tensors 142 corresponding to the users 101 represented by the vertices 132 in the graph 130, the social distance quantifier 118 can be configured to quantify a social distance based on interactions between a pair of users 101 using corresponding tensors 142. For example, as shown in FIG. 2D, the social distance can be computed using tensor distance metrics such as dot product distance, cosine similarity, or Euclidean distance. As such, for each user 101, the social distance quantifier 118 can produce a set of tensor distances 146. In the illustrated example, a tensor distance between User A and User B has a value of 0.9 while a tensor distance between User A and User C has a value of 0.1. As such, the relative values of the tensor distances 146 can reflect degrees of interactions between User A and Users B and C. In the illustrated example, smaller tensor distances correspond to closer relationships. In other examples, the tensor distances can have other suitable correspondence with closeness of relationships.

Based on the tensor distances 146, the social distance quantifier 118 can be configured to also rank users 101 for closeness to a user 101 based on interactions of among the users 101. For example, as shown in FIG. 2D, for User A, the list of ranked according to closeness is “User C, User B, User D,” For User B, the list of ranked according to closeness is “User C, User A, User D, . . . ” For User C, the list of ranked according to closeness is “User A, User B, User E, . . . ” Though the disclosed technique is described above in the context of user interactions with other users 101, similar techniques can also be applied in the context of user interactions with content or interactions with teams, groups, or other suitable types of organizations on a social network or other suitable types of computing network.

Several embodiments of the disclosed technology can be applied to resolve the technical issue of quantifying degrees of interactions in a computing platform such as a social network using machine learning. By constructing the interaction graph 130, interaction features or properties, such as exchange of emails, the number of emails exchanged, recency of exchanged emails, etc., can be graphically represented. The graphically represented interaction features can then be converted into vertex level tensors 146 in a vector space via graph embedding. Using the vertex level tensors 146, the data processor 110 can readily determine social distance values based on interactions between the users 101 as tensor distances 146 between pairs of the tensors. As such, social distance values corresponding to degrees of interactions of the users 101 can be readily quantified and visualized.

The quantified social distance values can be useful in providing suggestions of potential connections, content, or organizations based on user interactions in a social network. For example, when a new user (e.g., User T) joins a social network to replace a previous user (e.g., User A), the data processor 110 can be configured to suggest to the new user potential connections of other users 101 in the social network according to a ranking of social distance of the other users 101 to the previous user (e.g., User A). In another example, when a new user joins a social network but not to replace any other users 101, an average, medium, or other suitable values of tensors from other users 101 can be used to calculate estimated social distances from users 101. As such, the new user is likely to quickly establish valuable relationship with other users 101 with whom the new user is likely to interact. In further examples, the data processor 110 can also be configured to similarly suggest content items or groups to the new user such that the new user can be exposed to likely useful information or activities.

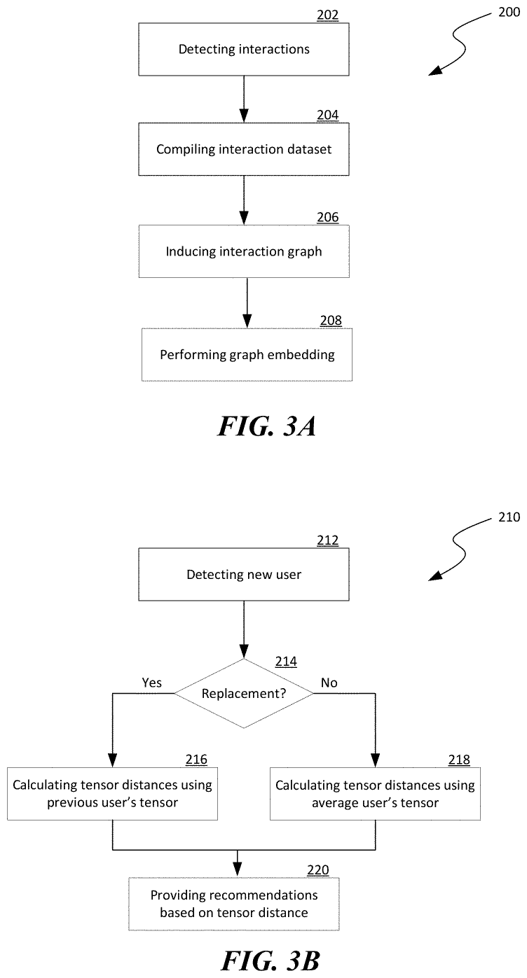

FIGS. 3A and 3B are flowchart illustrating example processes of interaction based social distance quantification and uses thereof in accordance with embodiments of the disclosed technology. Though processes are described below in the context of the computing platform 108 in FIG. 1, in other embodiments, the processes can also be implemented in social networks or other suitable types of computer networks with additional and/or different components.

As shown in FIG. 3A, a process 200 can include detection interactions at stage 202. Various example implementations for detecting interactions among users are described above with reference to FIGS. 1-2D. The process 200 can then include compiling the detected interaction data into an interaction dataset at stage 204. In certain embodiments, compiling the detected interaction data can include generating multiple database records. In other embodiments, compiling the detected interaction data can include generating a dataset in a table, matrix, or other suitable types of data format. The process 200 can then include inducing the complied interaction data into an interaction graph at stage 206. Various example techniques for performing graph inducing are described above with reference to FIG. 2B. The process 200 can then include performing graph embedding to convert the interaction graph into a set of tensors in a vector space at stage 208. Various example techniques for performing graph inducing are described above with reference to FIG. 2C.

FIG. 3B illustrates one example use of the converted set of tensors from FIG. 3A. As shown in FIG. 3B, a process 210 can include detecting a new user has joined a social network or other suitable types of network at stage 212. The process 210 can then include a decision stage 214 to determine whether the new user is a replacement of another existing user in the social network. In response to determining that the new user is a replacement, the process 210 proceeds to calculating tensor distance values using previous user's tensors and other users' tensors at stage 216. In response to determining that the new user is not a replacement, the process 210 proceeds to calculating tensor distance values using average user's tensors and other users' tensors at stage 218. Various example techniques for performing graph inducing are described above with reference to FIG. 2D. The process 210 can then include providing recommendations of possible connections to the new user based on the calculated tensor distance values at stage 220.

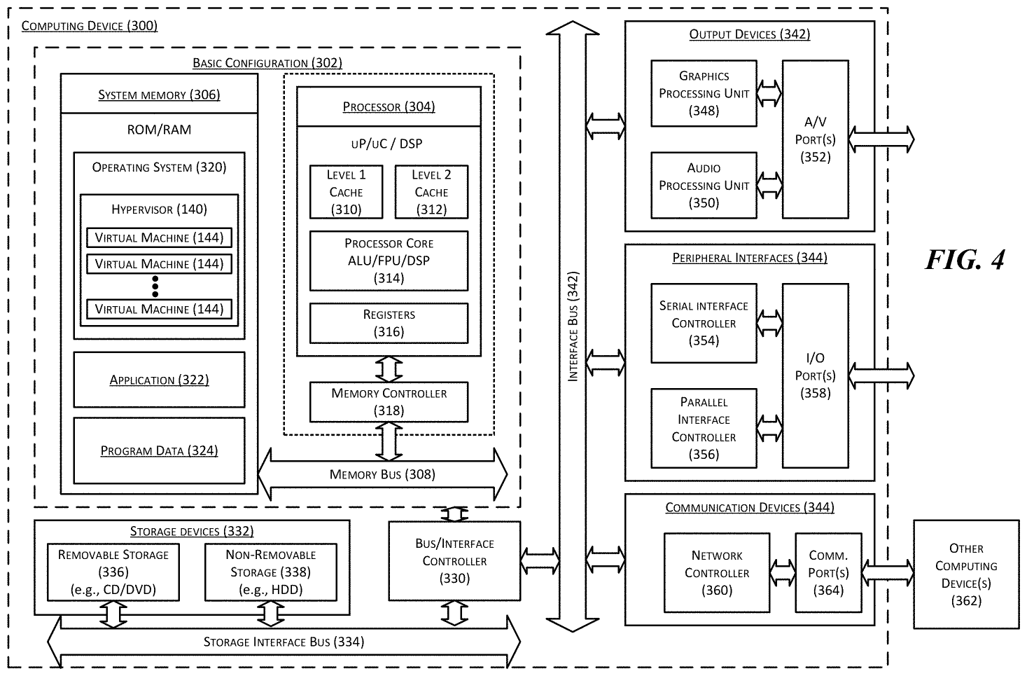

FIG. 4 is a computing device 300 suitable for certain components of the computing system 100 in FIG. 1, for example, the data processor 110, the email server 106, the client device 102, or the file management server 103. In a very basic configuration 302, the computing device 300 can include one or more processors 304 and a system memory 306. A memory bus 308 can be used for communicating between processor 304 and system memory 306. Depending on the desired configuration, the processor 304 can be of any type including but not limited to a microprocessor (pP), a microcontroller (pC), a digital signal processor (DSP), or any combination thereof. The processor 304 can include one more level of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 6 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable, and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information, and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more NV ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method of interaction based social distance quantification via graph embedding performed on a computer, the method comprising:
receiving, at the computer, a dataset containing data representing multiple interactions among multiple users via electronic messages in a social network interconnecting the multiple users;
based on the received dataset, generating an interaction graph having (i) multiple vertices individually corresponding to the multiple users and (ii) multiple directional edges individually connecting pairs of the multiple vertices, the individual edges indicating one or more interactions between the pairs of the multiple users;
applying graph embedding to the generated interaction graph to convert the multiple vertices in the generated graph into corresponding tensors in a vector space individually representing a position and a level of interaction between one of the multiple users and other users in the social network; and
determining a social distance value between the one of the multiple users and another of the multiple users by calculating a tensor distance in the vector space between tensors corresponding to the one of the multiple users and the another of the multiple users, thereby quantifying social distance between the one of the multiple users and the another of the multiple users.

2. The method of claim 1 wherein receiving the dataset includes receiving a dataset containing multiple interactions:
among the multiple users;
between the individual users with one or more content items in the social network; or
between the individual users with one or more groups in the social network.

3. The method of claim 1 wherein generating the interaction graph further includes assigning a weight to each of the directional edges according to a corresponding number of interactions between corresponding pairs of the multiple users.

4. The method of claim 1 wherein:
the interactions among the multiple users include interactions via emails among the multiple users, each of the emails having a number of recipients; and
generating the interaction graph further includes assigning a weight to each of the directional edges as inversely proportional to the number of recipients of the each of the emails.

5. The method of claim 1 wherein:
the interactions among the multiple users include interactions via emails among the multiple users, each of the emails having a number of recipients; and
generating the interaction graph further includes:
filtering at least one of the interactions via emails having more than a threshold number of recipients; and
assigning a constant weight to each of the directional edges corresponding to a remaining subset of the interactions after filtering the at least one of the interactions.

6. The method of claim 1 wherein applying graph embedding includes:
applying encoding functions to convert the individual vertices of the interaction graph into a tensor, the encoding functions individually having one or more parameters corresponding to non-linear transformations of an aggregation of connected neighbors of one of the vertices and of the vertex itself; and
utilizing a neural network to generate the one or more parameters such that the encoding functions can transform the vertices into corresponding tensor while preserving graph structure to a threshold degree.

7. The method of claim 1 wherein applying graph embedding includes:
applying encoding functions to convert the individual vertices of the interaction graph into a tensor, the encoding functions individually having one or more parameters corresponding to non-linear transformations of an aggregation of connected neighbors of one of the vertices and of the vertex itself; and
utilizing a neural network to generate the one or more parameters using a loss function based on random walks, graph factorization, or node proximity in a graph such that the encoding functions can transform the vertices into corresponding tensor while preserving graph structure to a threshold degree.

8. The method of claim 1 wherein applying graph embedding includes:
applying encoding functions to convert the individual vertices of the interaction graph into a tensor, the encoding functions individually having one or more parameters corresponding to non-linear transformations of an aggregation of connected neighbors of one of the vertices and of the vertex itself;
utilizing a neural network to generate the one or more parameters using a loss function based on random walks while applying different numbers of random walks based on a degree centrality of one of the vertices in the interaction graph such that the encoding functions can transform the vertices into corresponding tensor while preserving graph structure to a threshold degree.

9. The method of claim 1, further comprising:
detecting that a user has joined the social network to replace another user; and
in response to detecting that the user has joined the social network, generating a list of recommended connections to the user based on social distance values of the another user and additional users in the social network.

10. A computing device, comprising:
a processor; and
a memory operatively coupled to the processor, the memory including instructions executable by the processor to cause the computing device to:
upon receiving, at the computing device, a dataset containing data representing multiple interactions among multiple users via electronic messages in a social network interconnecting the multiple users;
generate a data structure representing an interaction graph having (i) multiple vertices individually corresponding to the multiple users and (ii) multiple directional edges individually connecting pairs of the multiple vertices, the individual edges indicating one or more interactions between the pairs of the multiple users;
apply graph embedding to the generated interaction graph to convert the multiple vertices in the generated graph into corresponding tensors in a vector space individually representing a position and a level of interaction between one of the multiple users and other users in the social network; and
determining a social distance value between the one of the multiple users and another of the multiple users by calculating a tensor distance in the vector space between tensors corresponding to the one of the multiple users and the another of the multiple users, thereby quantifying social distance between the one of the multiple users and the another of the multiple users.

11. The computing device of claim 10 wherein the multiple interactions include interactions:
among the multiple users;
between the individual users with one or more content items in the social network; or
between the individual users with one or more groups in the social network.

12. The computing device of claim 10 wherein to generate the interaction graph further includes to assign a weight to each of the directional edges according to a corresponding number of interactions between corresponding pairs of the multiple users.

13. The computing device of claim 10 wherein:
the interactions among the multiple users include interactions via emails among the multiple users, each of the emails having a number of recipients; and
to generate the interaction graph further includes to assign a weight to each of the directional edges as inversely proportional to the number of recipients of the each of the emails.

14. The computing device of claim 10 wherein:
the interactions among the multiple users include interactions via emails among the multiple users, each of the emails having a number of recipients; and
to generate the interaction graph further includes to:
filter at least one of the interactions via emails having more than a threshold number of recipients; and
assign a constant weight to each of the directional edges corresponding to a remaining subset of the interactions after filtering the at least one of the interactions.

15. The computing device of claim 10 wherein to apply graph embedding includes to:
apply encoding functions to convert the individual vertices of the interaction graph into a tensor, the encoding functions individually having one or more parameters corresponding to non-linear transformations of an aggregation of connected neighbors of one of the vertices and of the vertex itself; and
utilize a neural network to generate the one or more parameters using a loss function based on random walks, graph factorization, or node proximity in a graph such that the encoding functions can transform the vertices into corresponding tensor while preserving graph structure to a threshold degree.

16. The computing device of claim 10 wherein to apply graph embedding includes to:
apply encoding functions to convert the individual vertices of the interaction graph into a tensor, the encoding functions individually having one or more parameters corresponding to non-linear transformations of an aggregation of connected neighbors of one of the vertices and of the vertex itself;
utilize a neural network to generate the one or more parameters using a loss function based on random walks while applying different numbers of random walks based on a degree centrality of one of the vertices in the interaction graph such that the encoding functions can transform the vertices into corresponding tensor while preserving graph structure to a threshold degree.

17. A method of interaction based social distance quantification via graph embedding performed on a computer, the method comprising:
receiving, at the computer, a dataset containing data representing one or more interactions between a first user and a second user via electronic messages;
based on the received dataset, generating an interaction graph having (i) first and second vertices individually corresponding to the first and second users, respectively; and (ii) one or more directional edges individually connecting the first and second vertices, the individual edges indicating one or more interactions between the first and second users;
applying graph embedding to the generated interaction graph to convert the first and second vertices in the generated graph into first and second tensors in a vector space; and
determining a social distance value between the first and second users as a tensor distance in the vector space between first and second tensors, thereby quantifying social distance between the first and second users in the social network.

18. The method of claim 17 wherein generating the interaction graph further includes assigning a weight to each of the directional edges according to a corresponding number of interactions between the first and second users.

19. The method of claim 17 wherein:
the interactions between the first and second users include interactions via emails exchanged between the first and second users, each of the emails having a number of recipients; and
generating the interaction graph further includes assigning a weight to each of the directional edges as inversely proportional to the number of recipients of the each of the emails.

20. The method of claim 17 wherein:
the interactions between the first and second users include interactions via emails exchanged between the first and second users, each of the emails having a number of recipients; and
generating the interaction graph further includes:
removing, from the dataset, at least one of the interactions via emails having more than a threshold number of recipients; and
assign a constant weight to each of the directional edges corresponding to a remaining portion of the interactions in the dataset.
